(19) United States
(12) Patent Application Publication
(10) Pub. No.: US 2025/0264359 A1
(43) Pub. Date: Aug. 21, 2025

(54) DETECTION DEVICE

(71) Applicant: Japan Display Inc., Tokyo (JP)

(72) Inventor: Shinya ASAKURA, Tokyo (JP)

(21) Appl. No.: 19/050,349

(22) Filed: Feb. 11, 2025

(30) Foreign Application Priority Data
Feb. 15, 2024 (JP) 2024-020776

(51) Int. Cl. G01J 1/04; G01J 1/08; G01J 1/16; H05B 47/155

(52) U.S. Cl. CPC G01J 1/044; G01J 1/08; G01J 1/16; H05B 47/155

(57) ABSTRACT

According to an aspect, a detection device includes: a light source device; an object placement member; an electrochromic shutter having a plurality of divided regions arranged in a plane; and an optical sensor having a plurality of detection regions arranged in a plane. One of the detection regions includes one or more photodetection elements. The divided regions in the electrochromic shutter are capable of being switched between a light-transmitting state and a non-light-transmitting state for each of the divided regions, and the light-emitting elements are each capable of being switched between a lit state and an unlit state. The respective light-emitting elements, the respective divided regions of the electrochromic shutter, and the respective detection regions overlap when viewed in the first direction.

### CROSS-REFERENCE TO RELATED APPLICATION

This application claims the benefit of priority from Japanese Patent Application No. 2024-020776 filed on Feb. 15, 2024, the entire contents of which are incorporated herein by reference.

### BACKGROUND

### 1. Technical Field

What is disclosed herein relates to a detection device.

### 2. Description of the Related Art

Japanese Patent Publication No. 6830593 (JP-B-6830593) discloses a biosensor that includes an optical sensor including a photosensor (photodetection element), a culture vessel placed on the upper side of an imaging surface of the photosensor, and a point light source disposed above the culture vessel. The culture vessel accommodates therein a culture medium and a plurality of objects to be detected (microorganisms). In the biosensor of JP-B-6830593, light emitted from the point light source passes through the culture medium and the objects to be detected (microorganisms), and enters the photodiode. The biosensor of JP-B-6830593 may, however, have difficulty in detecting the objects to be detected if the culture medium in the culture vessel has low light transmittance.

Detection devices with higher accuracy of detection of the objects to be detected are required.

For the foregoing reasons, there is a need for a detection device that improves accuracy of detection of objects to be detected.

### SUMMARY

According to an aspect, a detection device includes: a light source device including a plurality of light-emitting elements arranged in a plane; an object placement member with a light-transmitting property that is disposed overlapping the light source device on a first side in a first direction and on which an object to be detected is placed; an electrochromic shutter that is disposed overlapping the object placement member on the first side in the first direction and has a plurality of divided regions arranged in a plane; and an optical sensor that is disposed overlapping the electrochromic shutter on the first side in the first direction and has a plurality of detection regions arranged in a plane. One of the detection regions includes one or more photodetection elements. The divided regions in the electrochromic shutter are capable of being switched between a light-transmitting state and a non-light-transmitting state for each of the divided regions, and the light-emitting elements are each capable of being switched between a lit state and an unlit state. The respective light-emitting elements, the respective divided regions of the electrochromic shutter, and the respective detection regions overlap when viewed in the first direction.

### BRIEF DESCRIPTION OF THE DRAWINGS

FIG. 1 is a perspective view schematically illustrating a detection device according to an embodiment of the present disclosure;

FIG. 2 is a perspective view of a state where a top plate is removed from FIG. 1;

FIG. 3 is a schematic view of the detection device according to the embodiment;

FIG. 4 is a schematic view illustrating a section of an electrochromic shutter;

FIG. 5 is a schematic diagram illustrating an example of the configuration of the electrochromic shutter;

FIG. 6 is a schematic circuit diagram illustrating the configuration of a switching element in the electrochromic shutter;

FIG. 7 is a block diagram illustrating an example of the configuration of the detection device;

FIG. 8 is a schematic view illustrating projection regions of light emitted from light-emitting elements;

FIG. 9 is a schematic view of the detection device according to the embodiment;

FIG. 10 is a schematic plan view of a light source device according to the embodiment;

FIG. 11 is a schematic plan view of the electrochromic shutter according to the embodiment;

FIG. 12 is a schematic plan view of an optical sensor according to the embodiment;

FIG. 13 is a schematic diagram illustrating an operating state of two light-emitting elements and two divided regions of the electrochromic shutter adjacent to each other in an X direction;

FIG. 14 is a flowchart illustrating a detection operation example of the detection device according to the embodiment;

FIG. 15 is a schematic view illustrating the order in which the light-emitting elements are turned on;

FIG. 16 is a schematic view illustrating the order in which the divided regions of the electrochromic shutter open; and

FIG. 17 is a schematic view illustrating the order in which photodetection elements of the detection device perform detection.

### DETAILED DESCRIPTION

The following describes a mode (embodiment) for carrying out the present disclosure in detail with reference to the drawings. The present disclosure is not limited to the description of the embodiment given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure.

To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present disclosure and the drawings, and detailed description thereof may not be repeated where appropriate.

In XYZ coordinates in the drawings, a Z direction (first direction) corresponds to the up-down direction; an X direction (second direction) corresponds to the right-left direction; and a Y direction (third direction) corresponds to the front-rear direction. The X direction intersects (at right angles) the Y and Z directions; the Y direction intersects (at right angles) the X and Z directions; and the Z direction intersects (at right angles) the X and Y directions. A Z1 side is one side in the first direction, and a Z2 side is the other side in the first direction. An end on an X2 side in the X direction is referred to as a first end, and the end on an X1 side is referred to as a second end. A plan view indicates a state viewed in the Z direction (first direction).

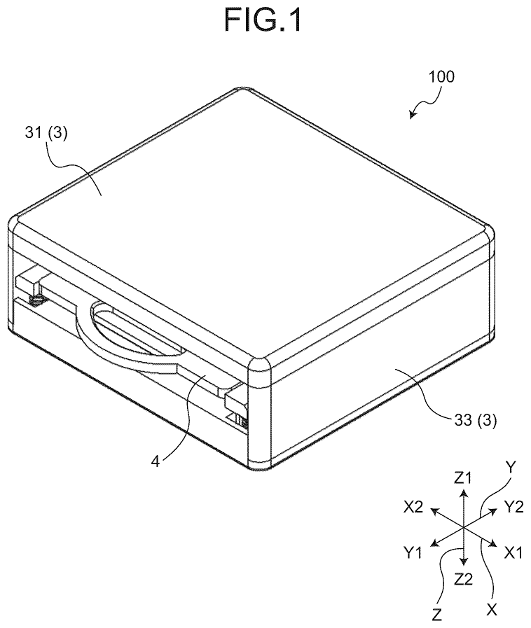

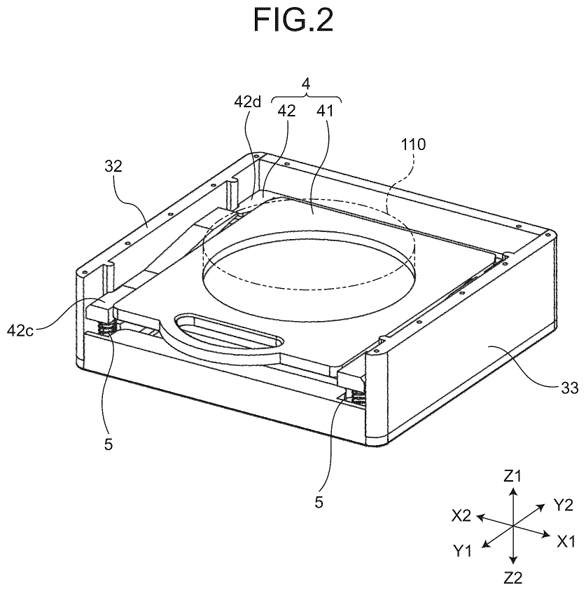

FIG. 1 is a perspective view schematically illustrating a detection device according to an embodiment of the present disclosure. FIG. 2 is a perspective view of a state where a top plate is removed from FIG. 1.

As illustrated in FIGS. 1 and 2, a detection device 100 has a substantially box shape, for example. The detection device 100 includes a housing 3 and a holding member 4. The housing 3 includes a top plate 31 and side plates 32 and 33. The holding member 4 includes a plate 41 and a base plate 42. An object placement member 110 is placed on the plate 41. The four corners of the base plate 42 are provided with front-side holders 42c and rear-side holders 42d. The front-side holders 42c and the rear-side holders 42d are biased to the upper side (Z1 side) by springs 5. The object placement member 110 is placed on the plate 41, whereby the plate 41 and the object placement member 110 are biased to the upper side (Z1 side) by the springs 5.

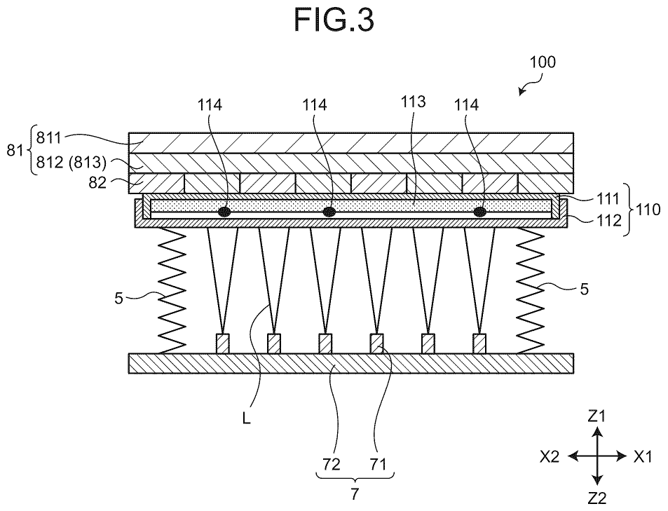

FIG. 3 is a schematic view of the detection device according to the embodiment. As illustrated in FIG. 3, the detection device 100 includes a light source device 7, the object placement member 110, an electrochromic shutter 82, an optical sensor 81, and the springs 5.

The light source device 7 includes a light source substrate 72 and a plurality of light-emitting elements 71. The light-emitting element 71 is a light-emitting diode (LED), for example. Thus, the light source device 7 includes a plurality of light-emitting elements 71 arranged in a plane.

The object placement member 110 includes a placement substrate 111 and a cover member 112. The object placement member 110 is a Petri dish, for example. The object placement member 110 has a light-transmitting property. The placement substrate 111 is a light-transmitting substrate disposed overlapping the light source device 7 on the Z1 side and on which objects to be detected 114 are placed.

The object placement member 110 according to the present embodiment is placed upside down with respect to a conventional object placement member. In other words, in the conventional object placement member, the placement substrate is placed on the lower side, and the cover member is placed on the upper side. By contrast, in the object placement member 110 according to the present embodiment, the placement substrate 111 is placed on the upper side, and the cover member 112 is placed on the lower side. The optical sensor 81 and the electrochromic shutter 82 are provided on top of (on the Z1 side of) the object placement member 110 placed upside down, and the light source device 7 is provided under (on the Z2 side of) the object placement member 110. A culture medium 113 (e.g., agar) is provided on the lower side of the placement substrate 111, and the objects to be detected 114 are applied to the culture medium 113 (lower surface of the culture medium 113). The object to be detected 114 is a microorganism, such as a bacterium, or a sample containing a microorganism and forms colonies on the culture medium 113 over time. The object to be detected 114 is not limited to the bacteria, and may be other micro-objects such as cells.

The optical sensor 81 includes an array substrate 811 and sensor pixels 812 (photodetection elements 813 or photodiodes). The optical sensor 81 is disposed overlapping the electrochromic shutter 82 on the Z1 side. The sensor pixels 812 are provided on the surface of the array substrate 811 on the Z2 side. The electrochromic shutter 82 will be described later.

Light L emitted from the light-emitting element 71 passes through the cover member 112, the culture medium 113, the placement substrate 111, and a divided region of the electrochromic shutter 82 in a light-transmitting state (open state) and travels toward the optical sensor 81. The amount of light incident on the photodetection element 813 (photodiode) of the optical sensor 81 differs between a region overlapping the object to be detected 114 and a region not overlapping the object to be detected 114. As a result, the optical sensor 81 can image the objects to be detected 114. Thus, the detection device 100 is a device that monitors changes in the objects to be detected 114 by placing the objects to be detected 114 accommodated in the object placement member 110 between the light source device 7 and the optical sensor 81 and imaging the objects to be detected 114 by the optical sensor 81.

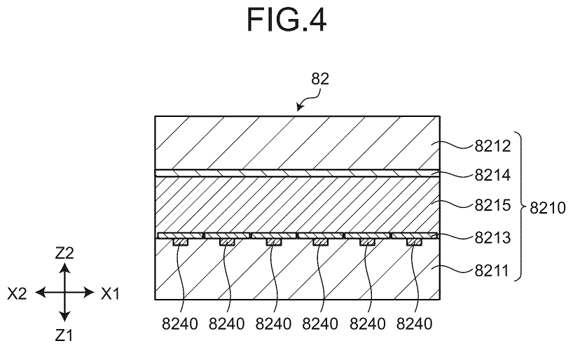

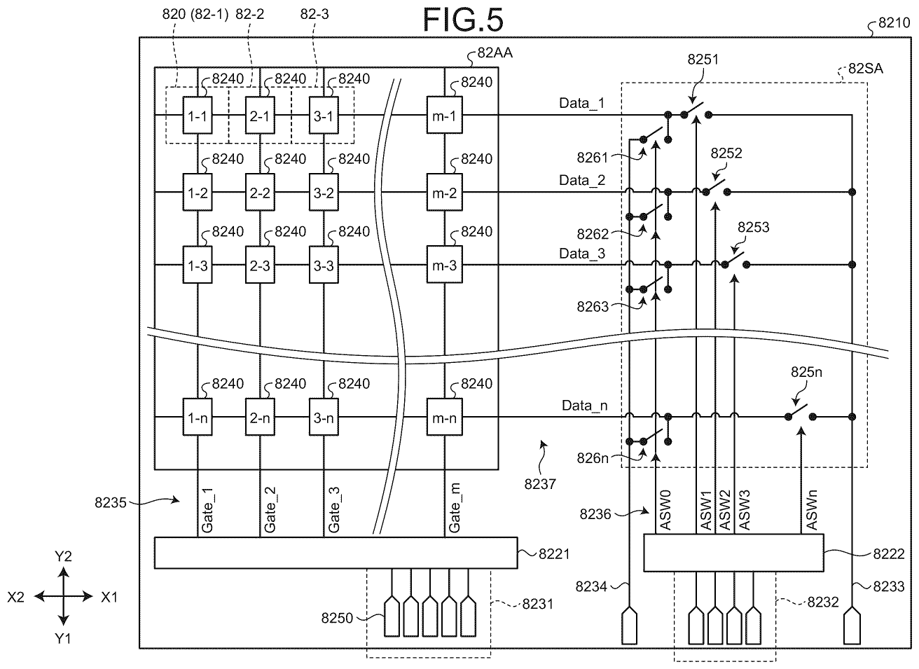

FIG. 4 is schematic view illustrating a section of the electrochromic shutter. FIG. 5 is a schematic diagram illustrating an example of the configuration of the electrochromic shutter.

The electrochromic shutter 82 is described below. In the following description, “electrochromic” in the electrochromic shutter may be abbreviated simply as “EC”. In other words, for example, the electrochromic shutter may be referred to as an EC shutter, and an electrochromic material may be referred to as an EC material. EC is an abbreviation for electrochromic.

As illustrated in FIG. 4, the electrochromic shutter 82 includes a first substrate 8211, a second substrate 8212, and an electrochromic material 8215. The EC material 8215 is sandwiched between the first substrate 8211 and the second substrate 8212 in the Z direction. The EC shutter 82 is a device that uses the EC material 8215 that can be reversibly controlled to be brought into a light-transmitting state or a non-light-transmitting state by controlling applied voltage. The EC material 8215 is an ion-insertion metal oxide, such as chromium oxide (Cr₂O₃) and tungsten oxide (WO₃), but it is not limited thereto and may be another material that produces similar phenomena.

The first substrate 8211 and the second substrate 8212 are light-transmitting substrates, such as glass substrates. The surface of the first substrate 8211 facing the EC material 8215 is provided with first electrodes 8213. The surface of the second substrate 8212 facing the EC material 8215 is provided with a second electrode 8214. The first electrode 8213 is coupled to a switching element 8240. The potential difference between the first electrode 8213 and the second electrode 8214 determines the voltage applied to the EC material 8215. The second electrode 8214 according to the embodiment is supplied with a constant potential.

As illustrated in FIG. 5, the EC shutter 82 includes an active area 82AA and a switching circuit area 82SA. In the active area 82AA, a plurality of switching elements 8240 are arranged in a matrix (row-column configuration). The switching elements 8240 correspond to respective divided regions 820 of the EC shutter 82. Some of the divided regions 820 are indicated by dashed lines. Specifically, out of the switching elements 8240 illustrated in FIG. 5, “1-1” corresponds to a divided region 82-1, “2-1” corresponds to a divided region 82-2, and “3-1” corresponds to a divided region 82-3. The divided regions 820 of the EC shutter 82 will be described later in detail.

In the EC shutter 82, signals input via wiring 8231 are supplied to the active area 82AA as drive signals via a gate driver 8221 and wiring 8235. Signals input via wiring 8232 are supplied to the switching circuit area 82SA via a decoder 8222 and wiring 8236. The potential of a signal input via a wiring line 8233 is supplied to the active area 82AA as an applied potential via the switching circuit area 82SA and wiring 8237. The potential of a signal input via a wiring line 8234 is supplied to the active area 82AA as a reset potential via the switching circuit area 82SA and the wiring 8237.

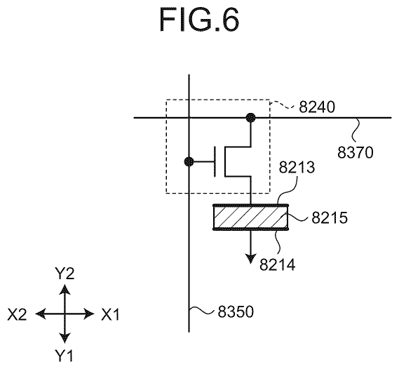

FIG. 6 is a schematic circuit diagram illustrating the configuration of the switching element in the electrochromic shutter. The switching element 8240 illustrated in FIG. 6 is a field effect transistor (FET). The gate of the switching element 8240 is coupled to a scanning line 8350. One of the source and the drain of the switching element 8240 is coupled to a transmission line 8370. The other of the source and the drain of the switching element 8240 is coupled to the first electrode 8213. In other words, at the timing when the signal (drive signal) is supplied to the gate via the scanning line 8350, the switching element 8240 supplies the first electrode 8213 with a potential corresponding to the potential (e.g., applied or reset potential) according to the signal transmitted via the transmission line 8370.

The transmission line 8370 illustrated in FIG. 6 is one of transmission lines Data_1, Data_2, Data_3, . . . , and Data_n illustrated in FIG. 5. The wiring 8237 includes a plurality of transmission lines, such as the transmission lines Data_1, Data_2, Data_3, . . . , and Data_n illustrated in FIG. 5. The transmission lines are coupled to the wiring 8233 via the switching circuit area 82SA. n is a natural number of 2 or larger indicating the number of the switching elements 8240 arranged in the Y direction and the number of transmission lines. The switching elements 8240 arranged in the X direction share a single transmission line with one another.

A plurality of transmission lines, such as the transmission lines Data_1, Data_2, Data_3, . . . , and Data_n, are coupled to the wiring line 8233 via individual first switches 8251, 8252, 8253, . . . , and 825n, respectively. As illustrated in FIG. 5, the transmission line Data_1 is coupled to the wiring 8233 via the first switch 8251. The transmission line Data 2 is coupled to the wiring line 8233 via the first switch 8252. The transmission line Data 3 is coupled to the wiring line 8233 via the first switch 8253. Similarly, the transmission line Data_n is coupled to the wiring line 8233 via the first switch 825n.

A plurality of transmission lines, such as the transmission lines Data_1, Data_2, Data_3, . . . , and Data_n, are coupled to the wiring 8234 via individual second switches 8261, 8262, 8263, . . . , and 826n, respectively. As illustrated in FIG. 5, the transmission line Data_1 is coupled to the wiring 8234 via the second switch 8261. The transmission line Data_2 is coupled to the wiring 8234 via the second switch 8262. The transmission line Data_3 is coupled to the wiring 8234 via the second switch 8263. Similarly, the transmission line Data_n is coupled to the wiring 8234 via the second switch 826n. The positions where the transmission lines are coupled to the second switches 8261, 8262, 8263, . . . , and 826n are closer to the active area 82AA than the positions where the transmission lines are coupled to the first switches 8251, 8252, 8253, . . . , and 825n.

The first switches 8251, 8252, 8253, . . . , and 825n and the second switches 8261, 8262, 8263, . . . , and 826n operate under the control of the decoder 8222.

The decoder 8222 is coupled to wiring lines ASW1, ASW2, ASW3, . . . , and ASWn that transmit signals to individually control the first switches 8251, 8252, 8253, . . . , and 825n. As illustrated in FIG. 5, the wiring line ASW1 couples the decoder 8222 to the first switch 8251. The wiring line ASW2 couples the decoder 8222 to the first switch 8252. The wiring line ASW3 couples the decoder 8222 to the first switch 8253. Similarly, the wiring line ASWn couples the decoder 8222 to the first switch 825n. The wiring 8236 includes the wiring lines ASW1, ASW2, ASW3, . . . , and ASWn.

The decoder 8222 is also coupled to a wiring line ASW0 that transmits signals to collectively control the second switches 8261, 8262, 8263, . . . , and 826n. The wiring line ASW0 couples the decoder 22 to the second switches 8261, 8262, 8263, . . . , and 826n. Besides the wiring lines ASW1, ASW2, ASW3, . . . , and ASWn, the wiring 8236 also includes the wiring line ASW0.

The decoder 8222 operates according to signals supplied from a host 8225 via the wiring 8232 and controls the operations of the first switches 8251, 8252, 8253, . . . , and 825n and the second switches 8261, 8262, 8263, . . . , and 826n. More specifically, the decoder 8222 functions as what is called a combinational logic circuit and can control the operations of the first switches 8251, 8252, 8253, . . . , and 825n and the second switches 8261, 8262, 8263, . . . , and 826n according to signals supplied via the wiring 8232 including a smaller number of wiring lines than the number of wiring lines included in the wiring 8236.

The scanning line 8350 illustrated in FIG. 6 is one of scanning lines Gate_1, Gate_2, Gate_3, . . . , and Gate_m illustrated in FIG. 5. The wiring 8235 includes a plurality of scanning lines, such as the scanning lines Gate_1, Gate_2, Gate_3, . . . , and Gate_m illustrated in FIG. 5. The gate driver 8221 operates according to signals supplied from the host 8225 via the wiring 8231 and sequentially supplies drive signals to the scanning lines Gate_1, Gate_2, Gate_3, . . . , and Gate_m. m is a natural number of 2 or larger indicating the number of the switching elements 8240 arranged in the X direction and the number of scanning lines. The switching elements 8240 arranged in the Y direction share a single scanning line with one another.

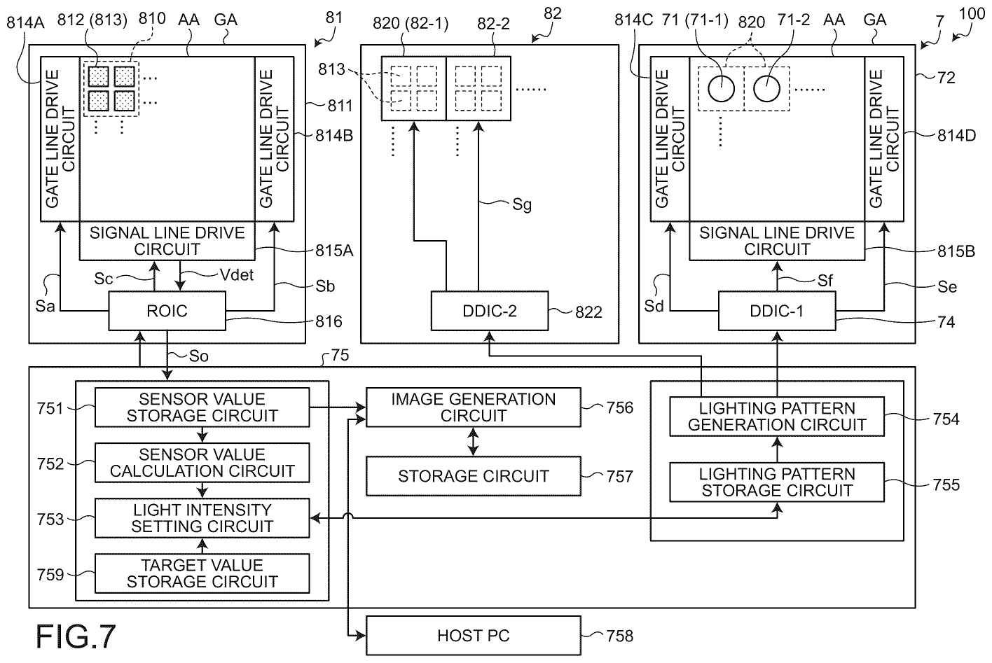

FIG. 7 is a block diagram illustrating an example of the configuration of the detection device. As illustrated in FIG. 7, the detection device 100 includes the optical sensor 81, the electrochromic shutter 82, the light source device 7, and a host IC 75. The optical sensor 81 includes the array substrate 811, the sensor pixels 812 (photodetection elements 813 or photodiodes) formed on the array substrate 811, gate line drive circuits 814A and 814B, a signal line drive circuit 815A, and a detection control circuit (ROIC) 816.

The array substrate 811 is formed using a substrate as a base. Each of the sensor pixels 812 is configured with a corresponding one of the photodetection elements 813, a plurality of transistors, and various types of wiring.

The array substrate 811 has a detection region AA and a peripheral region GA. The detection region AA is a region provided with the sensor pixels 812 (photodetection elements 813). The peripheral region GA is a region between the outer periphery of the detection region AA and the outer ends of the array substrate 811 and is a region not provided with the sensor pixels 812. The gate line drive circuits 814A and 814B, the signal line drive circuit 815A, and the detection control circuit 816 are provided in the peripheral region GA.

Each of the sensor pixels 812 is an optical sensor that includes the photodetection element (photodiode) 813 as a sensor element. Each of the photodetection elements 813 outputs an electrical signal corresponding to light emitted thereto.

The detection control circuit 816 is a circuit that supplies control signals Sa, Sb, and Sc to the gate line drive circuits 814A and 814B and the signal line drive circuit 815A, respectively, to control operations of these circuits. The detection control circuit 816 includes a signal processing circuit that performs signal processing on detection signals Vdet from the photodetection elements 813.

The detection control circuit 816 performs signal processing on the detection signals Vdet from the photodetection elements 813 and outputs sensor values So based on the detection signals Vdet to the host IC 75. Thus, the detection device 100 detects information on the object to be detected 114.

The electrochromic shutter 82 includes a plurality of divided regions 820 and a second light-emitting element control circuit (DDIC-2) 822. Each of the divided regions 820 is arranged overlapping a plurality of (e.g., four) photodetection elements 813. The second light-emitting element control circuit 822 supplies control signals Sg to the respective divided regions 820 and controls operations of these regions.

The light source device 7 includes the light source substrate 72, the light-emitting elements 71 formed on the light source substrate 72, gate line drive circuits 814C and 814D, a signal line drive circuit 815B, and a first light-emitting element control circuit (DDIC-1) 74.

The light-emitting elements 71 are arranged in a matrix (row-column configuration) in a region of the light source substrate 72 overlapping the detection region AA. The light source substrate 72 is a drive circuit substrate that drives each of the light-emitting elements 71 so as to switch the element between on (lit state) and off (unlit state). The light-emitting elements 71 are disposed overlapping the respective divided regions 820 of the electrochromic shutter 82.

The first light-emitting element control circuit 74 supplies control signals Sd, Se, and Sf to the gate line drive circuits 814C and 814D and the signal line drive circuit 815B, respectively, to control operations of these circuits.

The host IC 75 includes, as a control circuit for the optical sensor 81, a sensor value storage circuit 751, a sensor value calculation circuit 752, a light intensity setting circuit 753, and a target value storage circuit 759. The sensor value storage circuit 751 stores therein the sensor values So output from the detection control circuit 816 of the optical sensor 81. The sensor value calculation circuit 752 performs a predetermined calculation process on the sensor values So of the photodetection elements 813.

In a light intensity setting mode, the light intensity setting circuit 753 compares the sensor values So detected by the photodetection elements 813 with a preset target sensor value So-t acquired from the target value storage circuit 759 to set light intensities of the light-emitting elements 71 for detection. The target value storage circuit 759 stores therein the preset target sensor value So-t.

The host IC 75 includes, as a control circuit for the light source device 7, a lighting pattern generation circuit 754 and a lighting pattern storage circuit 755. The lighting pattern storage circuit 755 stores therein information on the light intensity of each of the light-emitting elements 71 in the light intensity setting mode.

The lighting pattern generation circuit 754 generates various control signals based on the information on the light intensity in the lighting pattern storage circuit 755.

The host IC 75 includes an image generation circuit 756 and a storage circuit 757. In a detection mode, the image generation circuit 756 generates an image of the object to be detected 114, based on the sensor values So output from the photodetection elements 813. The storage circuit 757 stores therein image data generated by the image generation circuit 756. The host IC 75 is coupled to a host computer (PC) 758 and transfers the image data to the host PC 758.

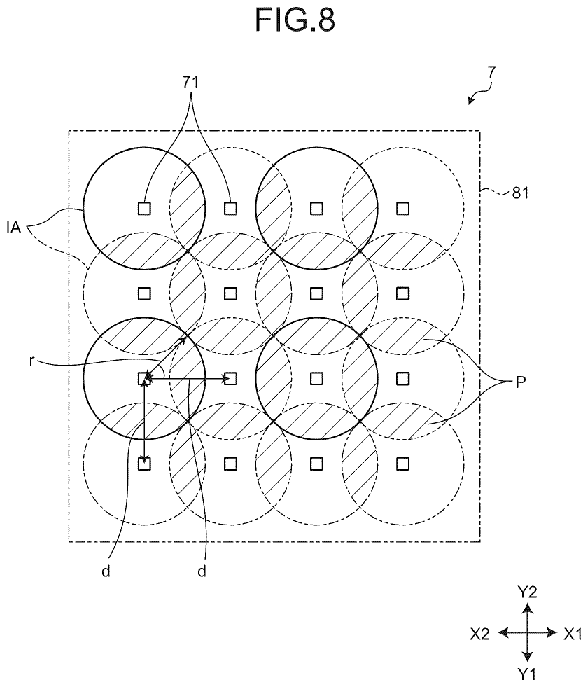

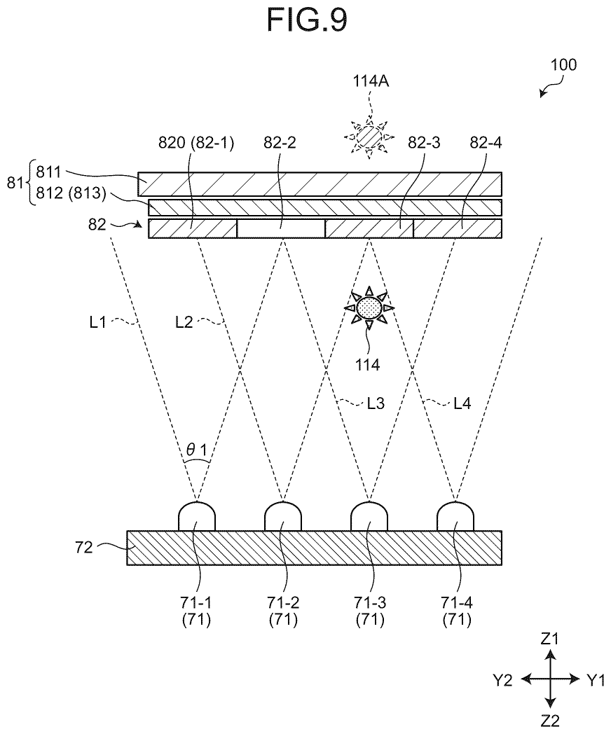

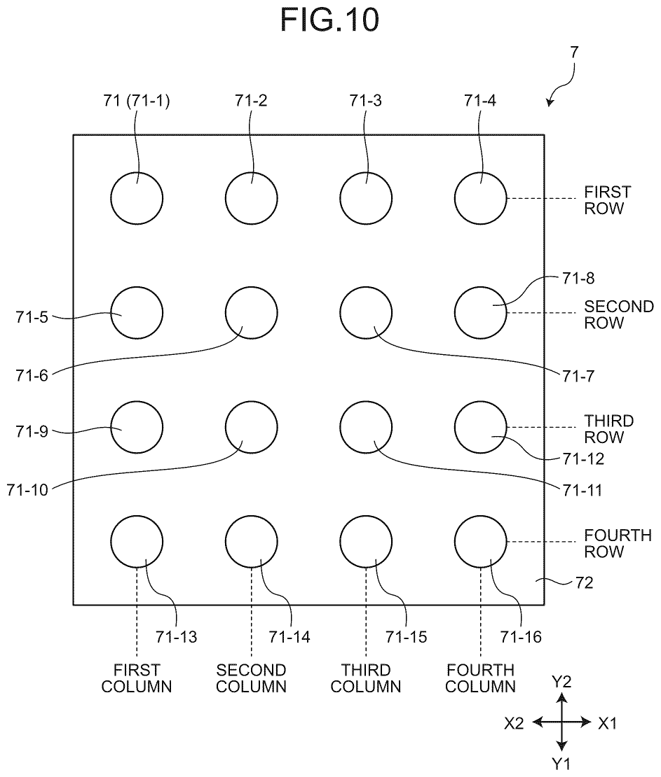

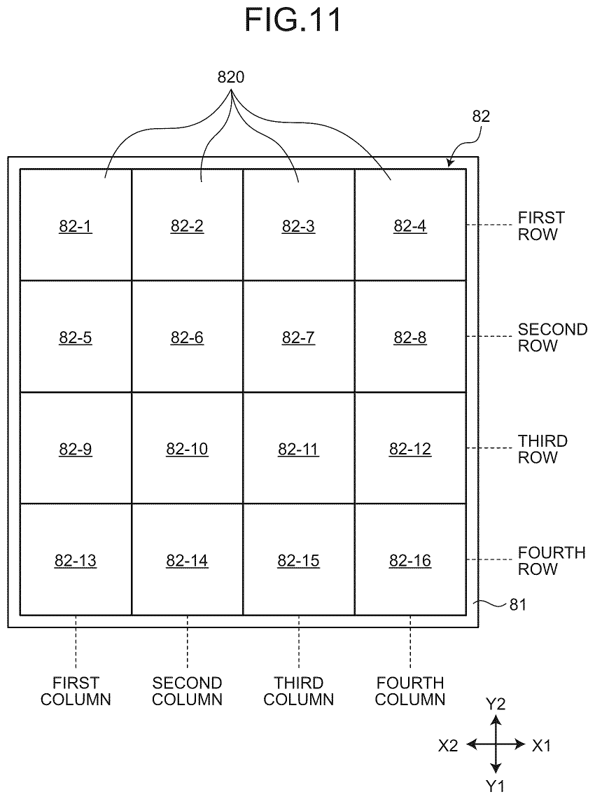

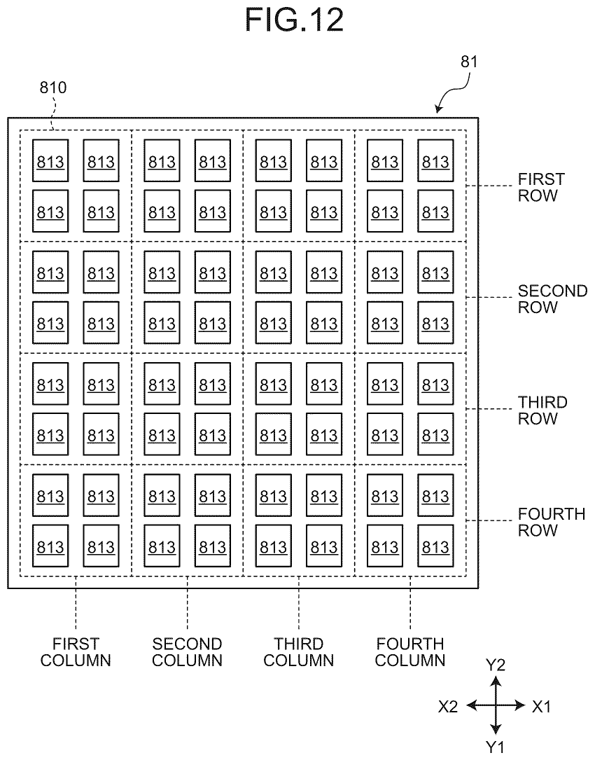

FIG. 8 is a schematic view illustrating projection regions of light emitted from the light-emitting elements. FIG. 9 is a schematic view of the detection device according to the embodiment. FIG. 10 is a schematic plan view of the light source device according to the embodiment. FIG. 11 is a schematic plan view of the electrochromic shutter according to the embodiment. FIG. 12 is a schematic plan view of the optical sensor according to the embodiment.

As illustrated in FIG. 8, a total of 16 light-emitting elements 71 according to the present embodiment are provided. In other words, the following describes the embodiment where n and m described with reference to FIG. 5 are 4. The 16 light-emitting elements 71 are arranged in a matrix (row-column configuration) at regular intervals in the X direction (second direction) and the Y direction (third direction). In the 16 light-emitting elements 71, the distance between the light-emitting elements 71 adjacent to each other in the X direction is a distance d, and the distance between the light-emitting elements 71 adjacent to each other in the Y direction is also the distance d.

As illustrated in FIG. 9, light emitted from one light-emitting element 71 spreads radially as the light travels toward the upper side (Z1 side). Therefore, as illustrated in FIG. 8, a projection region IA of light projected onto the optical sensor 81 without the electrochromic shutter 82 is a circle with a radius r centered on the light-emitting element 71. As illustrated in FIG. 8, the projection regions IA adjacent in the X or Y direction have an overlapping portion P indicated by hatching. This overlapping portion P causes the image of the object to be detected 114 to be blurred or hazy.

As illustrated in FIG. 10, a total of 16 light-emitting elements 71 according to the present embodiment are provided. The light-emitting elements 71 are turned on one by one. Specifically, for example, in a unit period when one light-emitting element 71-1 is on, the light-emitting elements 71 other than the light-emitting element 71-1 are off. In other words, the light-emitting elements 71 can be switched between the lit state and the unlit state for each of the light-emitting elements 71.

The 16 light-emitting elements 71 are arranged in a matrix (row-column configuration) at regular intervals in the X and Y directions as described above. Specifically, four rows along the X direction are arranged, and four columns along the Y direction are arranged. As for the rows, for example, the first row is positioned on the most Y2 side. In the first row, four light-emitting elements 71 are arranged at regular intervals from the X2 side to the X1 side. Specifically, light-emitting elements 71-1, 71-2, 71-3, and 71-4 are arranged from the X2 side to the X1 side. In the second row, four light-emitting elements 71 are arranged at regular intervals from the X2 side to the X1 side. Specifically, light-emitting elements 71-5, 71-6, 71-7, and 71-8 are arranged from the X2 side to the X1 side. In the third row, four light-emitting elements 71 are arranged at regular intervals from the X2 side to the X1 side. Specifically, light-emitting elements 71-9, 71-10, 71-11, and 71-12 are arranged from the X2 side to the X1 side. In the fourth row, four light-emitting elements 71 are arranged at regular intervals from the X2 side to the X1 side. Specifically, light-emitting elements 71-13, 71-14, 71-15, and 71-16 are arranged from the X2 side to the X1 side.

As for the columns, for example, the first column is positioned on the most X2 side. In the first column, four light-emitting elements 71 are arranged at regular intervals from the Y2 side to the Y1 side. Similarly, in the second, the third, and the fourth columns, four light-emitting elements 71 are arranged at regular intervals from the Y2 side to the Y1 side.

As illustrated in FIG. 11, the electrochromic shutter 82 according to the present embodiment is divided into a total of 16 parts in plan view seen in the Z direction. In other words, the electrochromic shutter 82 has 16 divided regions 820 divided in the X and Y directions.

The divided regions 820 are brought into a light-transmitting state one by one. In other words, one divided region 820 overlapping one lit light-emitting element 71 when viewed in the Z direction is brought into a light-transmitting state, and the divided regions 820 other than the one divided region 820 are brought into a non-light-transmitting state. Specifically, the divided regions 820 in the electrochromic shutter 82 can be switched between the light-transmitting state and the non-light-transmitting state for each of the divided regions 820. In the period during which one divided region 820 is in the light-transmitting state, the other divided regions 820 are in a closed (non-light-transmitting) state. In other words, the period during which one divided region 820 is in the light-transmitting state is different from the periods during which the other divided regions 820 are in the light-transmitting state.

The divided regions 820 adjacent to each other in the X or Y direction are arranged without a gap or with a slight gap interposed therebetween. All the divided regions 820 each have a square shape when viewed in the Z direction. The divided regions 820 are arranged in a matrix (row-column configuration) at regular intervals in the X and Y directions when viewed in the Z direction. The 16 divided regions 820 are arranged in a lattice pattern at regular intervals in the X and Y directions. Specifically, in the same manner as the arrangement of the light-emitting elements, four rows along the X direction are arranged, and four columns along the Y direction are arranged. As for the rows, for example, the first row is positioned on the most Y2 side. In the first row, four divided regions 820 are arranged at regular intervals from the X2 side to the X1 side. Specifically, divided regions 82-1, 82-2, 82-3, and 82-4 are arranged from the X2 side to the X1 side. In the second row, four divided regions 820 are arranged at regular intervals from the X2 side to the X1 side. Specifically, divided regions 82-5, 82-6, 82-7, and 82-8 are arranged from the X2 side to the X1 side. In the third row, four divided regions 820 are arranged at regular intervals from the X2 side to the X1 side. Specifically, divided regions 82-9, 82-10, 82-11, and 82-12 are arranged from the X2 side to the X1 side. In the fourth row, four divided regions 820 are arranged at regular intervals from the X2 side to the X1 side. Specifically, divided regions 82-13, 82-14, 82-15, and 82-16 are arranged from the X2 side to the X1 side.

As for the columns, for example, the first column is positioned on the most X2 side. In the first column, four divided regions 820 are arranged at regular intervals from the Y2 side to the Y1 side. Similarly, in the second, the third, and the fourth columns, four divided regions 820 are arranged at regular intervals from the Y2 side to the Y1 side.

The divided region 820 according to the present disclosure does not necessarily have a square shape in plan view. Thus, the divided region 820 may have, for example, an equilateral triangular shape or a polygonal shape with five or more sides in plan view.

As illustrated in FIG. 12, the optical sensor 81 has a plurality of detection regions 810. One detection region 810 includes one or more photodetection elements 813 (photodiodes). While one detection region 810 according to the present embodiment includes four photodetection elements 813, the present disclosure is not limited thereto, and one detection region 810 may include three or less or five or more photodetection elements 813. The detection region 810 is arranged correspondingly to the divided region 820 of the electrochromic shutter 82. Specifically, the outline of the detection region 810 overlaps the outline of the divided region 820 of the electrochromic shutter 82 when viewed in the Z direction. Therefore, four photodetection elements 813 are disposed overlapping one divided region 820 of the electrochromic shutter 82 when viewed in the Z direction.

The detection regions 810 are arranged in a matrix (row-column configuration) at regular intervals in the X and Y directions when viewed in the Z direction. The 16 detection regions 810 are arranged in a lattice pattern at regular intervals in the X and Y directions. Specifically, in the same manner as the arrangement of the light-emitting elements 71 and the divided regions 820 of the electrochromic shutter 82, four rows along the X direction are arranged, and four columns along the Y direction are arranged. As for the rows, for example, the first row is positioned on the most Y2 side. In the first row, four detection regions 810 are arranged at regular intervals from the X2 side to the X1 side. In the second row, four detection regions 810 are arranged at regular intervals from the X2 side to the X1 side. In the third row, four detection regions 810 are arranged at regular intervals from the X2 side to the X1 side. In the fourth row, four detection regions 810 are arranged at regular intervals from the X2 side to the X1 side.

Referring back to FIG. 7, the light-emitting elements 71 overlap the respective divided regions 820 of the electrochromic shutter 82 when viewed in the Z direction. The divided region 820 of the electrochromic shutter 82 overlaps the photodetection elements 813 when viewed in the Z direction. Therefore, the respective light-emitting elements 71, the respective divided regions 820 of the electrochromic shutter 82, and the respective detection regions 810 overlap when viewed in the Z direction. In the present embodiment, the number of light-emitting elements 71 overlapping one divided region 820 of the electrochromic shutter 82 may be two or more. The light-emitting element 71 is a light-emitting diode (LED), for example.

Also in FIG. 9, the divided region 82-1 overlaps the light-emitting element 71-1, the divided region 82-2 overlaps the light-emitting element 71-2, the divided region 82-3 overlaps the light-emitting element 71-3, and the divided region 82-4 overlaps the light-emitting element 71-4 when viewed in the Z direction. Light L1 emitted from the light-emitting element 71-1 is incident on the entire area of the divided region 82-1 and part of the divided region 82-2. Similarly, light L2 is incident on the entire area of the divided region 82-2, part of the divided region 82-1, and part of the divided region 82-3. Light L3 is incident on the entire area of the divided region 82-3, part of the divided region 82-2, and part of the divided region 82-4. Light L4 is incident on the entire area of the divided region 82-4 and part of the divided region 82-3. The irradiation angle of light emitted from the light-emitting element 71 is an angle θ1, and 114A denotes a captured image of the object to be detected.

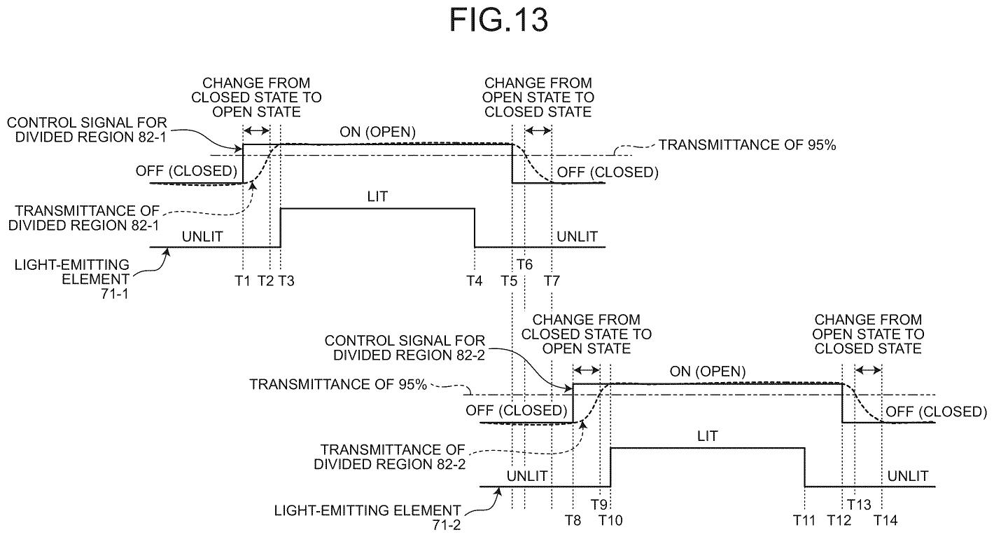

The following describes the operating timing of the electrochromic shutter 82 and the turning-on and -off timings of the light-emitting elements in comparison. FIG. 13 is a schematic diagram illustrating an operating state of two light-emitting elements and two divided regions of the electrochromic shutter adjacent to each other in the X direction.

In FIG. 13, the upper left diagram illustrates the turning-on and -off timings of the light-emitting element 71-1 (refer to FIG. 10) and the operating state of the divided region 82-1 (refer to FIG. 11) of the EC shutter 82. The light-emitting element 71-1 and the divided region 82-1 overlap when viewed in the Z direction. In FIG. 13, the lower right diagram illustrates the turning-on and -off timings of the light-emitting element 71-2 (refer to FIG. 10) and the operating state of the divided region 82-2 (refer to FIG. 11) of the EC shutter 82. The light-emitting element 71-2 and the divided region 82-2 overlap when viewed in the Z direction.

The control signal Sg (refer to FIG. 7) for instructing the shutter to open and close is indicated by a solid line, and the transmittance of the shutter is indicated by a dashed line. The highest transmittance of the EC shutter 82 is 100%, and the lowest transmittance is 0%. In the present embodiment, a transmittance of 95% is indicated by an alternate long and two short dashes line because a predetermined transmittance at which satisfactory detection accuracy can be obtained is 95% or higher.

First, the divided region 82-1 of the EC shutter 82 receives the control signal Sg (refer to FIG. 7) to open (turn on) the shutter at time T1 as indicated by the solid line. After the control signal Sg is received, the transmittance of the divided region 82-1 of the EC shutter 82 gradually increases. The transmittance reaches 95% at time T2 and is saturated near 100% at time T3. In the embodiment, a state where the transmittance is 95% or higher is the state where the EC shutter 82 is in the light-transmitting state (open state), and a state where the transmittance is lower than 5%, for example, is the non-light-transmitting state (closed state). Therefore, the divided region 82-1 of the EC shutter 82 comes into the light-transmitting state (open state) at time T2. The time length from time T1 to time T2 is determined in advance by experiment, for example. Thus, it is determined that the transmittance of the EC shutter 82 reaches 95% at the time when (time T2−time T1) has elapsed since time T1.

At time T3, the light-emitting element 71-1 shifts from the unlit state (off state) to the lit state. The light-emitting element 71-1 remains in the lit state from time T3 to time T4. At time T4, the light-emitting element 71-1 shifts to the unlit state.

When the control signal Sg to close (turn off) the shutter is received at time T5 after time T4, the transmittance of the divided region 82-1 of the EC shutter 82 gradually decreases from time T5. The transmittance of the divided region 82-1 reaches 95% at time T6 and is saturated near 0% at time T7. The transmittance reaches 95% at time T6, whereby the divided region 82-1 of the EC shutter 82 comes into the closed state at time T6.

After time T7, the light-emitting element 71-2 is brought into the lit and unlit states, and the divided region 82-2 of the EC shutter 82 is brought into the open state. The changes between the lit and unlit states of the light-emitting element 71-2 are the same as those in the light-emitting element 71-1, and the open and closed states of the divided region 82-2 of the EC shutter 82 are the same as those in the divided region 82-1.

Specifically, the divided region 82-2 of the EC shutter 82 first receives the control signal Sg to open (turn on) the shutter at time T8 as indicated by the solid line. After the control signal Sg is received, the transmittance of the divided region 82-2 of the EC shutter 82 gradually increases. The transmittance reaches 95% at time T9 and is saturated near 100% at time T10.

At time T10, the light-emitting element 71-2 shifts from the unlit state (off state) to the lit state. The light-emitting element 71-2 remains in the lit state from time T10 to time T11. At time T11, the light-emitting element 71-2 shifts to the unlit state.

When the control signal Sg to close (turn off) the shutter is received at time T12 after time T11, the transmittance of the divided region 82-2 gradually decreases from time T12. The transmittance reaches 95% at time T13 and is saturated near 0% at time T14.

After this, the light-emitting elements 71-3 and 71-4 are sequentially brought into the lit state in the same manner, and the divided regions 82-3 and 82-4 are brought into the open state in the same manner.

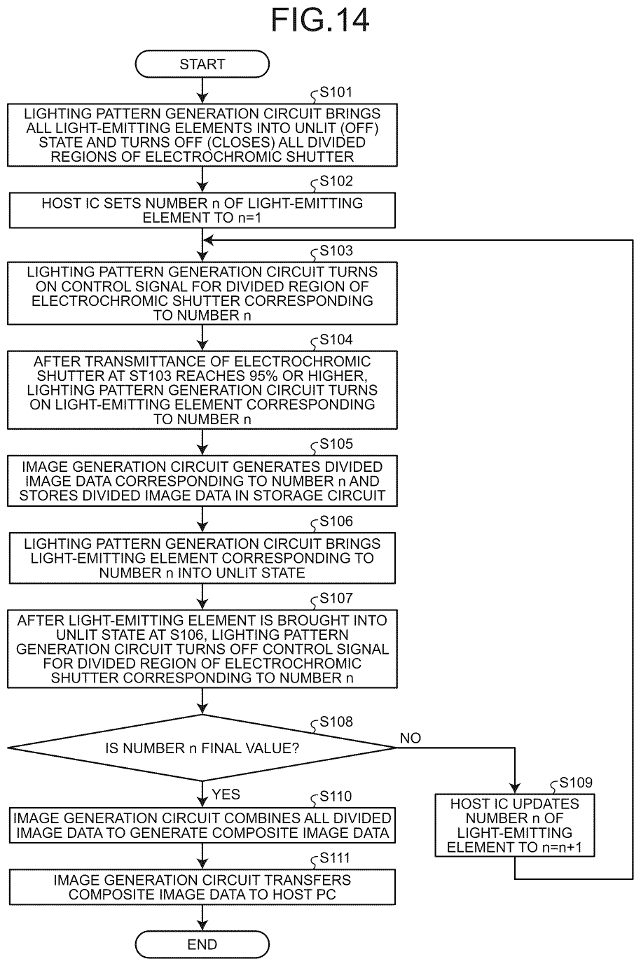

The following describes a detection operation example of the detection device. FIG. 14 is a flowchart illustrating the detection operation example of the detection device according to the embodiment.

First, the lighting pattern generation circuit 754 (refer to FIG. 7) brings all the light-emitting elements 71 into the unlit (off) state and turns off (closes) all the divided regions 820 of the electrochromic shutter 82 at Step S101. As a result, all the 16 light-emitting elements 71 illustrated in FIG. 10 are in the unlit state, and all the 16 divided regions 820 illustrated in FIG. 11 are in the off state.

Subsequently, the host IC 75 (refer to FIG. 7) sets the number n of the light-emitting element 71 to 1 (n=1) (Step S102).

Then, the lighting pattern generation circuit 754 turns on the control signal for the divided region 820 of the electrochromic shutter 82 corresponding to the number n (Step S103). As a result, the divided region 82-1 of the EC shutter 82 receives the control signal Sg to open (turn on) the shutter at time T1 as described with reference to FIG. 13, for example.

Subsequently, after the transmittance of the divided region 820 of the electrochromic shutter 82 reaches 95% or higher by the processing at Step S103, the lighting pattern generation circuit 754 turns on the light-emitting element 71 corresponding to the number n (Step S104). As a result, the light-emitting element 71-1 shifts from the unlit state (off state) to the lit state at time T3 as described with reference to FIG. 13, for example.

Then, the image generation circuit 756 (refer to FIG. 7) generates divided image data corresponding to the number n and stores it in the storage circuit 757 (Step S105). As a result, the divided image data corresponding to the divided region 82-1 illustrated in FIG. 11 is generated and stored.

Subsequently, the lighting pattern generation circuit 754 brings the light-emitting element 71 corresponding to the number n into the unlit state (Step S106). As a result, the light-emitting element 71-1 shifts from the lit state to the unlit state at time T4 as described with reference to FIG. 13, for example.

After the light-emitting element 71 is brought into the unlit state at Step S106, the lighting pattern generation circuit 754 turns off the control signal for the divided region 820 of the electrochromic shutter 82 corresponding to the number n (Step S107). As a result, when the control signal Sg to close (turn off) the shutter is received at time T5 after time T4, the transmittance of the divided region 82-1 of the EC shutter 82 gradually decreases from time T5 as described with reference to FIG. 13, for example.

The host IC 75 determines whether the number n is the final value (Step S108). If the number n is not determined to be the final value, the host IC updates the number n of the light-emitting element to n+1 (n=n+1) (Step S109). For example, the host IC 75 updates n=1 to n=2, and the lighting pattern generation circuit 754 performs the processing at Step S103 again.

Then, the processing from Step S103 to Step S107 is performed, and the host IC 75 determines whether the number n is the final value again (Step S108), and the processing is repeated until the number n is determined to be the final value.

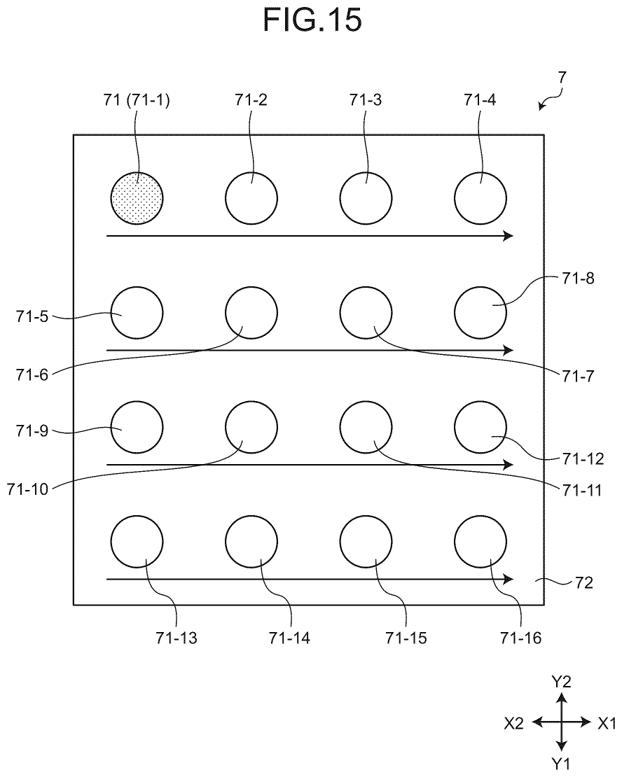

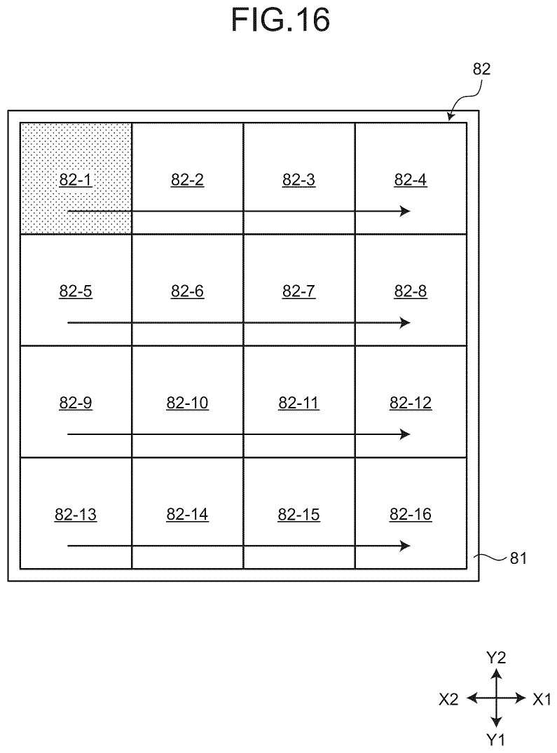

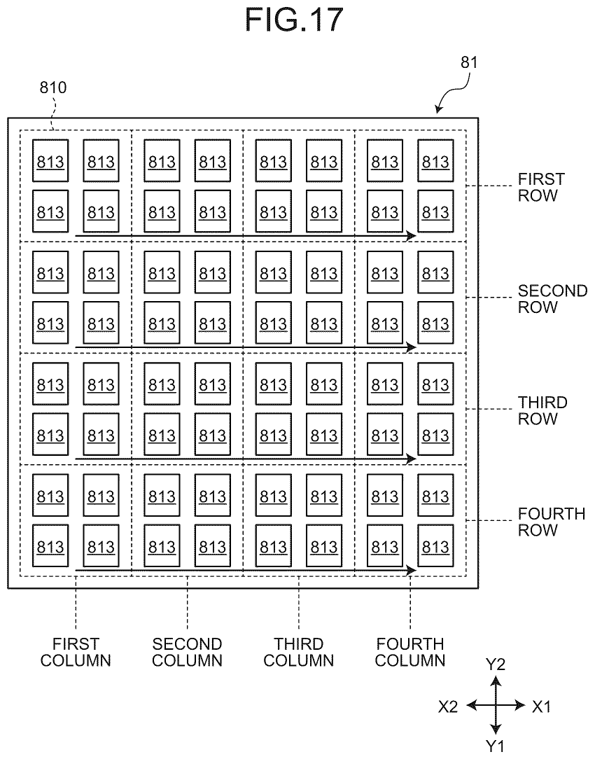

The following specifically describes the order in which the light-emitting elements 71 are turned on, the order in which the divided regions 820 of the electrochromic shutter 82 are brought into the light-transmitting state, and the order in which the photodetection elements 813 in the detection regions 810 of the optical sensor 81 perform detection, with reference to FIGS. 15, 16, and 17. FIG. 15 is a schematic view illustrating the order in which the light-emitting elements are turned on. FIG. 16 is a schematic view illustrating the order in which the divided regions of the electrochromic shutter open. FIG. 17 is a schematic view illustrating the order in which the photodetection elements of the detection device perform detection.

As illustrated in FIG. 15, as for the light-emitting elements 71, the light-emitting elements 71 of the first row are turned on one by one toward the X1 side. As illustrated in FIG. 16, as for the divided regions 820 of the electrochromic shutter 82, the divided regions 820 of the first row are brought into the light-transmitting state one by one toward the X1 side. As illustrated in FIG. 17, as for the photodetection elements 813, detection is sequentially performed on the detection regions 810 of the first row, for each of the detection regions 810. As described above, the “light-transmitting state” or the “open state” of the divided region 820 of the electrochromic shutter 82 means that the light transmittance is 95% or higher.

For example, when the light-emitting element 71-1 illustrated in FIG. 15 is turned on as indicated by halftone dot, the divided region 82-1 of the electrochromic shutter 82 illustrated in FIG. 16 is brought into the light-transmitting state, and detection is performed by the four photodetection elements 813 included in the detection region 810 in the first row and the first column illustrated in the FIG. 17. Subsequently, the light-emitting element 71-2 at the position shifted by one toward the X1 side is turned on, the divided region 82-2 is brought into the light-transmitting state, and detection is performed by one detection region 810 overlapping the divided region 82-2. After the lighting and detection are performed one by one on the first row, the processing is performed on the second row. Specifically, the light-emitting element 71-5 in the second row and the first column is turned on, the divided region 82-5 is brought into the light-transmitting state, and detection is performed by one detection region 810 overlapping the divided region 82-5. Detection is performed thereafter by the detection regions 810 at the positions shifted one by one toward the X1 side. When the processing on the second row is completed, detection is repeatedly performed from the third row to the fourth row in the same manner, and detection by the detection region 810 positioned in the fourth row and the fourth column is the final detection.

Referring back to the flowchart in FIG. 14, if the host IC 75 determines that the number n is the final value (Step S108), the image generation circuit 756 combines all the divided image data to generate composite image data (Step S110). Thus, the composite image data in all the regions illustrated in FIG. 17 is generated. The image generation circuit 756 transfers the composite image data to the host PC 758 (Step S111).

As described above, the detection device 100 includes the light source device 7, the object placement member 110 with a light-transmitting property, the electrochromic shutter 82 having a plurality of divided regions 820, and the optical sensor 81 having a plurality of detection regions 810. One detection region 810 includes one or more photodetection elements 813. The divided regions 820 in the electrochromic shutter 82 can be switched between the light-transmitting state and the non-light-transmitting state for each of the divided regions 820, and the light-emitting elements 71 can be switched between the lit state and the unlit state for each of the light-emitting elements 71. The respective light-emitting elements 71, the respective divided regions 820 of the electrochromic shutter 82, and the respective detection regions 810 overlap when viewed in the Z direction.

As described above, if a plurality of light-emitting elements 71 are provided, light rays in different directions are emitted from the light-emitting elements 71 to one object to be detected 114, which may blur an image captured by the optical sensor 81.

By contrast, in the present embodiment, the respective light-emitting elements 71, the respective divided regions 820 of the electrochromic shutter 82, and the respective detection regions 810 of the optical sensor 81 overlap when viewed in the Z direction. Therefore, by turning on one light-emitting element 71 and bringing the divided region 820 overlapping the light-emitting element 71 into the light-transmitting state, the detection device 100 reduces a plurality of light rays incident on the detection region 810 overlapping the divided region 820 in the light-transmitting state. This configuration can reduce blurring of the image captured by the optical sensor 81.

The divided region 820 that overlaps the light-emitting element 71 in the lit state when viewed in the Z direction is brought into the light-transmitting state, and the divided region 820 overlapping the light-emitting element 71 in the unlit state when viewed in the Z direction is brought into the non-light-transmitting state.

This configuration can turn on one light-emitting element 71, bring only the divided region 820 overlapping the light-emitting element 71 into the light-transmitting state, and bring the divided regions 820 other than the one divided region 820 into the non-light-transmitting state. Therefore, the light L transmitted through the divided region 820 in the light-transmitting state is limited to the light L emitted from the light-emitting element 71. This configuration can further reduce blurring of the image captured by the optical sensor 81.

The light-emitting elements 71, the divided regions 820, and the detection regions 810 are arranged in a matrix (row-column configuration) along the X direction (second direction) intersecting the Z direction (first direction) and the Y direction (third direction) intersecting the Z and X directions. When N is a natural number, the light-emitting elements 71 arranged in the N-th row are sequentially brought into the lit state from the end (first end) on the X2 side in the X direction to the end (second end) on the X1 side, and the divided regions 820 arranged in the N-th row are sequentially brought into the light-transmitting state from the first end on the X2 side in the X direction to the second end on the X1 side. After the lit state and the light-transmitting state in the N-th row are ended, the light-emitting elements 71 arranged in the N+1-th row are brought into the lit state, and the divided regions 820 arranged in the N+1-th row are brought into the light-transmitting state.

Thus, each of the divided regions 820 is brought into the lit state, and each of the detection regions 810 is brought into the light-transmitting state, whereby the detection regions 810 can sequentially detect the light L. Therefore, an image with higher detection accuracy can be obtained by combining the images detected by all the detection regions 810.

The light-emitting elements 71 include, for example, the light-emitting element 71-1 (first light-emitting element) and the light-emitting element 71-2 (second light-emitting element) adjacent to the light-emitting element 71-1 on the X1 side with respect to the light-emitting element 71-1. The divided regions 820 include, for example, the divided region 82-1 (first divided region) overlapping the light-emitting element 71-1 (first light-emitting element) when viewed in the Z direction and the divided region 82-2 (second divided region) overlapping the light-emitting element 71-2 (second light-emitting element) when viewed in the Z direction. The light-emitting element 71-1 is brought into the unlit state and the divided region 82-1 is brought into the non-light-transmitting state before the light-emitting element 71-2 is brought into the lit state and the divided region 82-2 is brought into the light-transmitting state.

Specifically, as described with reference to FIG. 13, the period during which the light-emitting element 71-2 is in the lit state and the divided region 82-2 is in the light-transmitting state is the period from time T10 to time T11. Therefore, before time T10, the light-emitting element 71-1 is brought into the unlit state, and the divided region 82-1 is brought into the non-light-transmitting state. In other words, after the divided region 82-1 is brought into the non-light-transmitting state, the light-emitting element 71-2 is brought into the lit state and the divided region 82-2 is brought into the light-transmitting state. Therefore, the light L from the light-emitting element 71-2 can be detected by only one detection region 810 overlapping the divided region 82-2 when viewed in the Z direction. As a result, an image with higher detection accuracy can be obtained.

The transmittance of the divided region 82-1 (first divided region) is controlled to start to increase before the light-emitting element 71-1 (first light-emitting element) is turned on.

Specifically, referring to FIG. 13, the time at which the light-emitting element 71-1 (first light-emitting element) is turned on is time T3. The time at which the transmittance of the divided region 82-1 (first divided region) starts to increase is time T1. In other words, time T1 comes before time T3. The response speed of the electrochromic shutter 82 is slower than that of a liquid crystal shutter, for example. Therefore, by setting the time (timing) at which the transmittance of the divided region starts to increase earlier, the detection device 100 can reduce a plurality of light rays incident on one detection region 810. This configuration can further reduce blurring of the image captured by the optical sensor 81.

The light-emitting element 71-1 (first light-emitting element) is controlled to be in the lit state when the transmittance of the divided region 82-1 (first divided region) is equal to or higher than a predetermined value with respect to the maximum transmittance. The predetermined value is, for example, 95%.

Specifically, as described with reference to FIG. 13, the period during which the transmittance of the divided region 82-1 (first divided region) is equal to or higher than a predetermined value of 95% is from time T2 to time T6. In the period from time T2 to time T6, the light-emitting element 71-1 is in the lit state. In other words, whenever the light-emitting element 71-1 is in the lit state, the divided region 82-1 is in the light-transmitting state. This configuration reduces a plurality of light rays incident on one detection region 810, thereby further reducing blurring of the image captured by the optical sensor 81.

The transmittance of the divided region 82-1 (first divided region) is controlled to start to decrease after the light-emitting element 71-1 (first light-emitting element) is brought into the unlit state.

Specifically, referring to FIG. 13, the time at which the light-emitting element 71-1 (first light-emitting element) is brought into the unlit state is time T4. The time at which the transmittance of the divided region 82-1 (first divided region) starts to decrease is time T5. Time T5 comes after time T4. In other words, whenever the light-emitting element 71-1 is in the unlit state, the divided region 82-1 is in the non-light-transmitting state. This configuration reduces a plurality of light rays incident on one detection region 810, thereby further reducing blurring of the image captured by the optical sensor 81.

What is claimed is:

1. A detection device comprising:
a light source device comprising a plurality of light-emitting elements arranged in a plane;
an object placement member with a light-transmitting property that is disposed overlapping the light source device on a first side in a first direction and on which an object to be detected is placed;
an electrochromic shutter that is disposed overlapping the object placement member on the first side in the first direction and has a plurality of divided regions arranged in a plane; and
an optical sensor that is disposed overlapping the electrochromic shutter on the first side in the first direction and has a plurality of detection regions arranged in a plane, wherein
one of the detection regions includes one or more photodetection elements,
the divided regions in the electrochromic shutter are capable of being switched between a light-transmitting state and a non-light-transmitting state for each of the divided regions, and the light-emitting elements are each capable of being switched between a lit state and an unlit state, and
the respective light-emitting elements, the respective divided regions of the electrochromic shutter, and the respective detection regions overlap when viewed in the first direction.

2. The detection device according to claim 1, wherein a divided region overlapping a light-emitting element in a lit state when viewed in the first direction out of the divided regions is brought into the light-transmitting state, and a divided region overlapping the light-emitting element in an unlit state when viewed in the first direction is brought into a non-light-transmitting state.

3. The detection device according to claim 2, wherein
the light-emitting elements, the divided regions, and the detection regions are arranged in a matrix having a row-column configuration along a second direction intersecting the first direction and a third direction intersecting the first direction and the second direction, and
when N is a natural number,
the light-emitting elements arranged in an N-th row are sequentially brought into the lit state from a first end in the second direction to a second end, and the divided regions arranged in the N-th row are sequentially brought into the light-transmitting state from the first end in the second direction to the second end, and
after the lit state and the light-transmitting state in the N-th row are ended, the light-emitting elements arranged in an N+1-th row are brought into the lit state, and the divided regions arranged in the N+1-th row are brought into the light-transmitting state.

4. The detection device according to claim 3, wherein
the light-emitting elements include a first light-emitting element and a second light-emitting element adjacent to the first light-emitting element on the second end side in the second direction with respect to the first light-emitting element,
the divided regions include a first divided region overlapping the first light-emitting element when viewed in the first direction and a second divided region overlapping the second light-emitting element when viewed in the first direction, and
the first light-emitting element is brought into the unlit state and the first divided region is brought into the non-light-transmitting state before the second light-emitting element is brought into the lit state and the second divided region is brought into the light-transmitting state.

5. The detection device according to claim 4, wherein the transmittance of the first divided region is controlled to start to increase before the first light-emitting element is turned on.

6. The detection device according to claim 4, wherein the first light-emitting element is controlled to be in the lit state when the transmittance of the first divided region is equal to or higher than a predetermined value with respect to a maximum transmittance.

7. The detection device according to claim 4, wherein the transmittance of the first divided region is controlled to start to decrease after the first light-emitting element is brought into the unlit state.

8. The detection device according to claim 6, wherein the predetermined value is 95%.
